(19) United States
(12) Patent Application Publication
(10) Pub. No.: US 2007/0245074 A1
(43) Pub. Date: Oct. 18, 2007

(54) Ring with on-chip buffer for efficient message passing

(76) Inventors: Mark B. Rosenbluth, Uxbridge, MA (US); Thomas R. Clancy, Stering, MA (US)

Correspondence Address: INTEL CORPORATION;c/o INTELLEVATE, LLC, P.O. BOX 52050, MINNEAPOLIS, MN, 55402, US

(21) Appl. No.: 11/396,043

(22) Filed: Mar. 30, 2006

(51) Int. Cl. G06F 12/00

(52) U.S. Cl. 711/110

(57) ABSTRACT

An embodiment of the present invention provides low latency, high capacity rings by combining a low latency memory with a higher latency memory. A small capacity, low latency memory, referred to as the ring buffer is used to store the head of the ring. If the ring buffer allocated to a given ring becomes full, data at the tail of the ring is spilled out to higher latency memory. When space becomes available in the ring buffer as a result of data being removed from the head of the ring, spilled data from the higher latency memory is refilled to low latency memory.

### FIELD

The present invention relates generally to communication mechanisms, and more particularly to management of a ring.

### BACKGROUND

A network processor is a programmable device that is optimized for processing packets at high speed. As the processing time available for processing received packets decreases in proportion to the increase in the rate at which packets are transmitted over a network, a network processor may include a plurality of programmable packet-processing engines to process packets in parallel. The packet-processing engines run in parallel, with each packet processing engine handling packets for a different flow or connection which can be processed independently from each other.

As the incoming rate of packets is typically bursty and the time to process packets is variable because it is based on packet content, communication between threads running on the packet-processing engines is typically performed through the use of rings to provide elasticity between producer threads and consumer threads. A producer thread may get ahead of a consumer thread in a short term interval. However, over some longer interval, the rate of the consumer thread and producer thread match.

A ring is a circular first-in-first-out data structure that includes a base address, length, head address and tail address which is used to pass information. The ring also includes memory elements that are allocated for storing data. The tail address or pointer is used to add (“put”, “enqueue”, “push”) a new entry onto the tail of the ring, and the head address or pointer is used to remove (“get”, “dequeue”, “pop”) entries from the head of the ring.

A ring is typically implemented using an array in memory to store the data passed in the ring, and a pair of pointers or offsets into that array which increment linearly through the entries in the array and “wrap” from the end of the array back to the beginning of the array.

The memory is typically statically allocated to the ring based on worst case backlog and thus is unavailable for other use. However, the memory capacity is not used efficiently as the majority of the time a lot of the ring capacity is not used.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a block diagram of an embodiment of a network processor;

FIG. 2 illustrates producer threads and consumer threads exchanging messages in a ring;

FIG. 3 is a block diagram of an embodiment of a communication mechanism according to the principles of the present invention;

FIG. 4 illustrates utilization of Dynamic Random Access Memory (DRAM) in a no spill case;

FIG. 5 illustrates utilization of the DRAM in a spill case;

FIG. 6 illustrates utilization of the DRAM in a refill case;

FIG. 7 is a flow diagram illustrating an embodiment of a method for managing a ring according to the principles of the present invention; and

FIG. 8 illustrates an embodiment for utilizing the ring buffer shown in FIG. 3.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

Shared memory for rings may be included on the same chip (die) as packet processing engines that use the rings or may be on a separate chip, for example in an external Static Random Access Memory (SRAM) or Dynamic Random Access Memory (DRAM). The advantage of on-chip rings is low latency; the disadvantage is small capacity due to the limited silicon area that can be allocated to the rings. The off-chip rings in external memory have the opposite trade-off, slower latency but greater capacity.

An embodiment of the present invention provides low latency, high capacity rings by combining the low latency of on-chip rings with the high capacity of off-chip rings. A small on-chip (internal) low latency memory, referred to as a ring buffer is used to store the head of the ring. If the ring buffer allocated to a given ring becomes full, data from the tail of the ring in the ring buffer is spilled out to off-chip (external) high latency memory. When the ring buffer occupancy drops, spilled data from off-chip memory is refilled to the ring buffer.

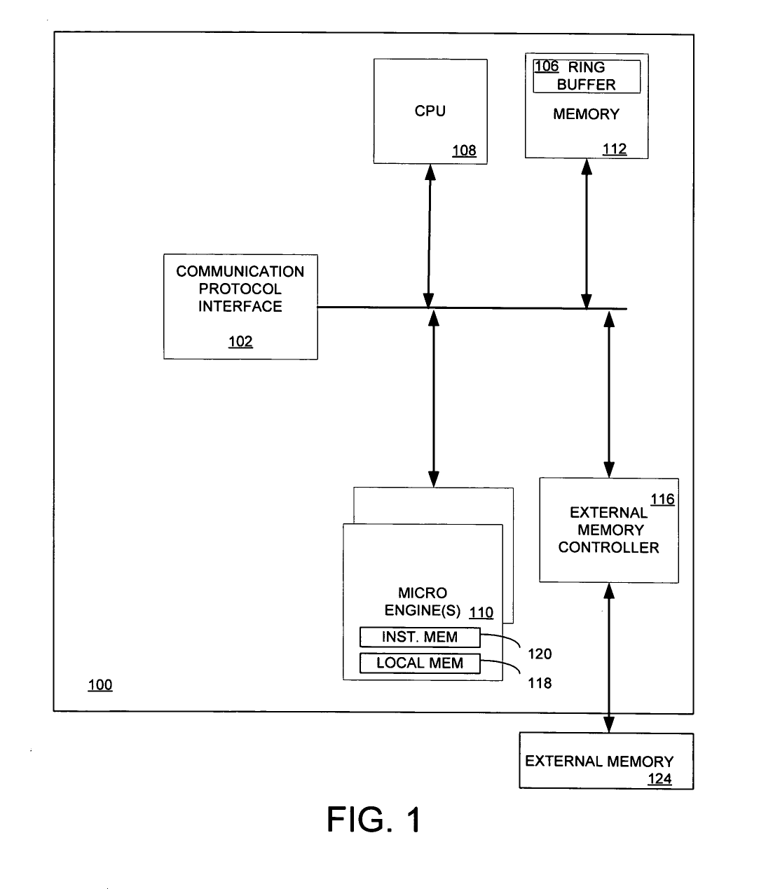

FIG. 1 is a block diagram of an embodiment of a network processor 100.

The network processor 100 includes a communications protocol interface 104, an external memory controller 116, a processor (Central Processing Unit (CPU)) 108 and a plurality of micro engines 110.

Network processing has traditionally been partitioned into control-plane and data-plane processing. Data plane tasks are typically performance-critical and non-complex, for example, classification, forwarding, filtering, header checking modification, protocol conversion and policing. Control plane tasks are typically performed less frequently and are not as performance sensitive as data plane tasks, for example, connection setup and teardown, routing protocols, fragmentation and reassembly.

The CPU 108 may be a 32 bit general purpose processor which may be used for offloading control plane tasks and handling exception packets from the micro engines 110.

In an embodiment, each micro engine 110 is a 32-bit processor with an instruction set and architecture specially optimized for fast-path data plane processing. In one embodiment, there are sixteen multi-threaded micro engines 110, with each micro engine 110 having eight threads. Each thread has its own context, that is, program counter and thread-local registers. Each thread has an associated state which may be inactive, executing, ready to execute or asleep. Only one of the eight threads can be executing in a micro engine 110 at any time. While the micro engine 110 is executing one of the eight threads, the other threads sleep waiting for memory or Input/Output accesses to complete. Each micro engine 110 includes memory (instruction store) 120 for storing instructions for each thread. In an embodiment, a 4 Kilo Byte (kB) instruction store may be provided for storing instructions. Each micro-engine may also include local memory 118. In an embodiment, each micro engine has 640 words of local memory 118 for storing data.

The external memory controller 116 controls access to external (off-chip) memory 124 which may be used for buffering packets and large data structures, for example, route tables and flow descriptors. The external memory may be Dynamic Random Access Memory (DRAM) or Static Random Access Memory (SRAM).

The internal (on-chip) memory 112 provides hardware-assisted ring buffers 106 for communication between micro engines 110. In an embodiment, the internal memory 112 is 16 kB. The internal memory 112 is shared by all of the micro engines 112. Control and status registers that may be accessed by the micro engines 110 may also be stored in the internal memory 112. In one embodiment, the internal memory 112 supports 16 rings, with one ring for each of the 16 micro engines 112, each of which supports atomic put and get operations.

A ring buffer 106 implements a First-In-First-Out (FIFO) data structure. In one embodiment, the ring buffer 106 includes a plurality of fixed-sized rings (circular FIFOs). As the rates of tasks (threads) producing and consuming on a ring may not be identical, the ring insulates the tasks from temporary bursts or stalls in either a consumer or a producer thread. Also, the rings allow a single or multiple producer thread(s) to be coupled with single or multiple consumer thread(s). For example, in a packet processing system where some packets require different processing than others, the packet ordering on a single ring is maintained due to the FIFO nature of the ring.

The communications protocol interface 102 buffers network packets as they enter and leave the network processor 100. In one embodiment, the communications protocol interface 102 may include support for the Media Access Control (MAC) protocol with Direct Memory Access (DMA) capability which handles packets as they enter and leave the network processor 100.

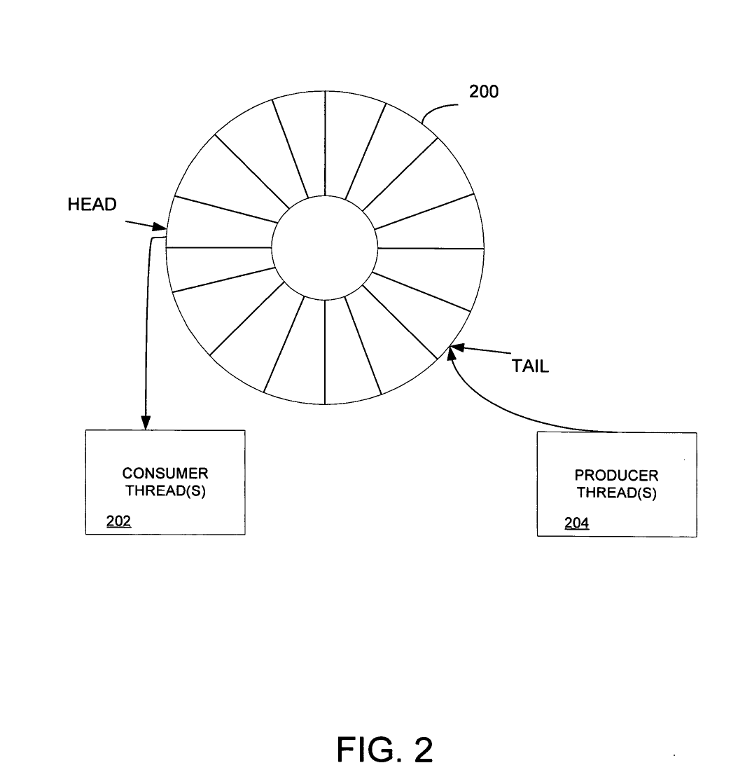

FIG. 2 illustrates producer threads 204 and consumer threads 202 exchanging messages in a ring 200. As shown, the ring 200 is implemented as a circular array, with pointers to the first and last entries on the ring, called the head and tail pointers respectively. Producer threads 204 produce messages which are added to the tail of the ring while consumer threads 202 consume messages from the head of the ring 200. In the network processor 100 shown in FIG. 1, the ring 200 provides an efficient means of message passing between micro engines 110 (FIG. 1) or between the CPU 108 (FIG. 1) and any one of the microengines 110 (FIG. 1).

The head and tail pointers are modified during put and get operations on the ring 200. After an entry is put on the ring 200 as a result of a put operation, the tail pointer is advanced. Similarly, after a get operation to remove an entry from the ring, the head pointer is advanced. The count of entries on the ring is determined using the head and tail pointers. Both the head and tail pointers wrap around the ring, so as not to exceed the size of the ring.

The put operation and get operation may each be implemented by a put instruction or get instruction executed by the micro engine 110 (FIG. 1). In one embodiment, the put instruction writes data to the tail of the ring number supplied in the put instruction and the get operation removes data from the head of the ring number supplied in the get instruction.

In a ring 200 in which memory is statically allocated, the maximum number of elements on the ring 200 is pre-defined at initialization, by the amount of memory allocated to the ring 200. Even though there may be empty elements on the ring, these empty elements occupy memory space. However, in contrast to linked-list queues, memory is not required to store links because all elements are stored in consecutive addresses.

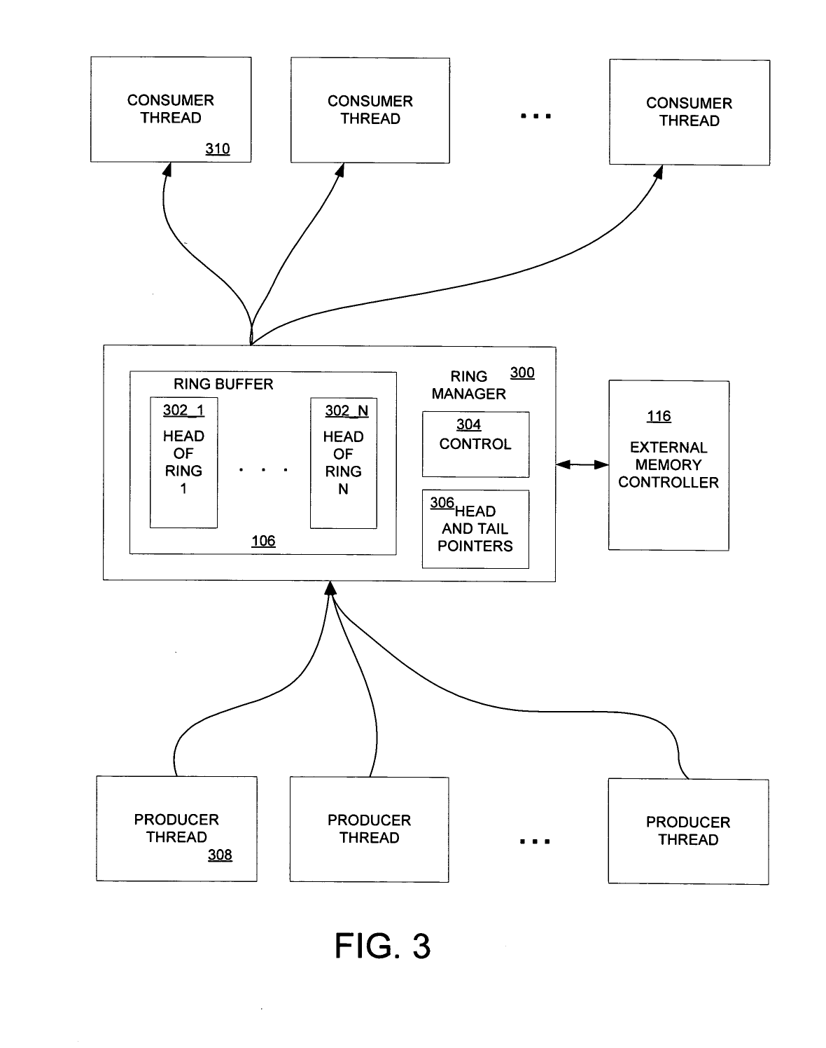

FIG. 3 is a block diagram of an embodiment of a communication mechanism according to the principles of the present invention. The communication mechanism provides the advantages of off-chip and on-chip rings. An on-chip ring manager 300 manages rings. The ring manager 300 includes some control logic 304, head and tail pointers 306 and some data memory referred to as a “ring buffer” 106. In one embodiment the control logic 304 is embodied in a hardware state machine. The ring buffer 106 is allocated for providing the head of ring portion for each ring. As shown in FIG. 3, the ring buffer 106 includes head of ring portions 302-1, . . . , 302-N, one for each of N-rings.

The producer and consumer threads direct put and get requests to the ring manager 300. Space for each ring is allocated in the external memory 124. In one embodiment, the external memory 124 is inexpensive, high latency, high capacity, Dynamic Random Access Memory (DRAM). DRAM is much less expensive per byte than on-chip (internal) memory and thus can provide an inexpensive high capacity ring in conjunction with the small on-chip ring buffer 106. Because external memory 124 is typically inexpensive in contrast to on-chip memory, large capacity rings, for example, 512 Kilo Bytes (kB) may be allocated. The ring manager 300 also allocates some space in the ring buffer 106 for each ring (head of ring 302-1, . . . , 302-N), for example 1 kB. Support for 16 rings would therefore require 16 kB, which can be included on-chip. Typically, 16 kB of on-chip memory may be provided in a network processor.

Data retrieved and stored in response to a put request or get request is retrieved from on-chip (internal) memory, that is, head of ring 302-1 . . . , 302-N in the ring buffer 106. When the head of ring portion 302 of the ring buffer 106 associated with a particular ring is full, data for new put requests is written to external memory 124 having a higher latency than the on-chip (internal) memory. When a get operation frees space in the ring buffer 106, the ring manager 300 refills the head of ring portion 302-1 . . . , 302-N in the ring buffer 106 from external memory 124 as previously discussed. However, the head of ring 302-1 . . . , 302-N in the ring buffer 106 still has data to provide in response to a get request while the external memory read completes. Thus, the long external memory read latency is hidden while data is provided from the ring buffer 106.

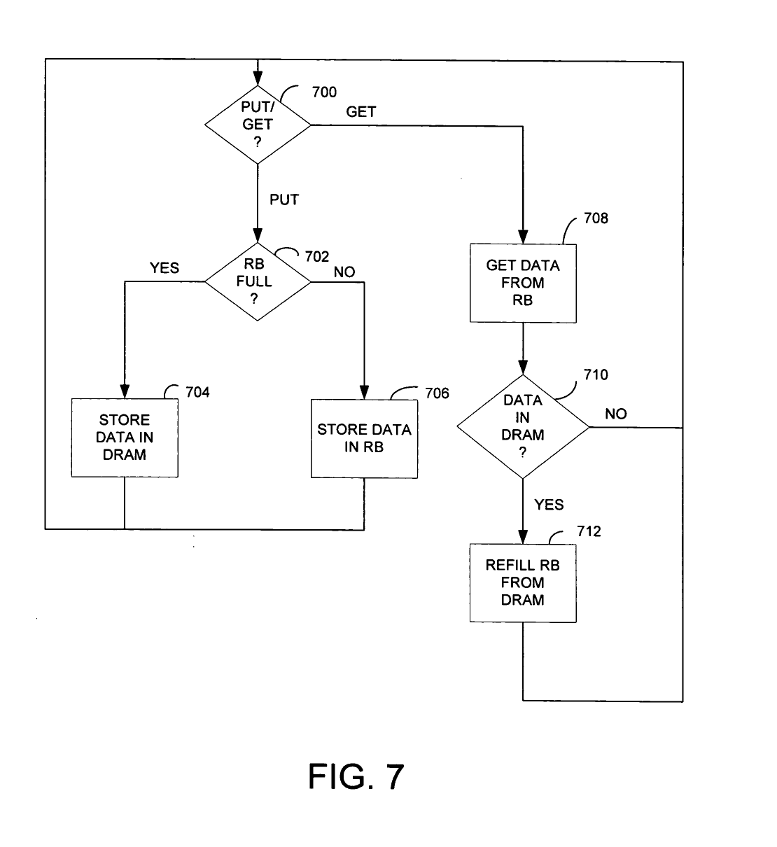

The control logic 304 may include a sequencer (a state machine with associated data path logic) for controlling spilling and refilling to/from off-chip memory. The operation of the sequencer will be described later in conjunction with FIG. 7.

Statically allocating memory with equal amounts per ring (for example, 1 kB each for each of 16 rings in a 16 kB ring buffer) is not required. Rings with higher data rates can be statically allocated a larger share of the ring buffer 106, so as to minimize the amount of times the ring buffer 106 for those rings becomes full. In an alternate embodiment, the ring buffer 106 may be dynamically allocated to rings on an as-needed basis. In this embodiment, lightly used rings use very little memory, leaving more memory to be allocated to heavily used rings.

For example, 16 kB of internal memory may be partitioned as some number of blocks, for example 256 blocks of 64 bytes per block. Initially all the blocks are in a free pool. When data is put onto a ring, a block is allocated for the data. Additional puts to the ring are stored in the allocated block. When the allocated block is full, another block is allocated for the ring. When get operations empty a block, the block is returned to the free pool.

Rings are typically used to provide for short term elasticity between producer and consumer threads. The amount of data on the ring grows when producer threads run ahead of consumer threads for a short period of time, and then shrinks as consumers catch up. If the amount of data on the ring does not often exceed the amount of local buffering in the ring buffer 106, then little or no data is stored in external memory.

DRAM performance is sensitive to access size. Many put and get accesses are for small amounts of data, for example 4 or 8 bytes. DRAMs typically have larger access quantums, for example 32 or 64 bytes per line, that is, the DRAM burst size. Accesses of smaller size than the access quantum are functionally possible, but take the same amount of time as the full quantum, for example, reading 8 bytes from a DRAM with 32 byte access size will achieve only 25% ( 8/32) efficiency; all 32 bytes are read, but 24 are dropped internally by the external memory controller 116.

In an alternate embodiment, the ring manager 300 improves DRAM efficiency by coalescing multiple put requests in a buffer in the ring manager 300 until the DRAM quantum size has been buffered. For example, the data from multiple put requests is stored in the buffer until an aligned 32 byte block is available before writing DRAM. DRAM efficiency is also improved by delaying refilling of the local memory from DRAM after a get operation to wait until there is at least a quantum size of space free in ring buffer before doing the DRAM read.

When space configured in the ring buffer 106 for a ring is tuned to the average ring occupancy and producer thread 308 and consumer thread 310 rates match, the ring stays relatively empty, and data is not written to or read from DRAM (external memory 124). When the consumer thread 310 falls behind, the ring occupancy increases and data at the tail of the ring is spilled (written) to DRAM

When the consumer thread 310 catches up with the producer thread 308, the spilled data is read from DRAM and written back to the ring buffer 106. As in the case of the spill operation, in one embodiment, data in the ring buffer 106 is refilled from the DRAM in DRAM burst sizes, that is, the DRAM Write/Read operations for spill and refill operation are aligned, full burst lines or an integral multiple of the DRAM burst size that improve DRAM performance. If a get request is received from a consumer thread when the on-chip ring buffer is empty and the refill from DRAM has not yet complete, the get operation stalls until the refill data is in the ring buffer 106. Stalls may be minimized by increasing the size of the ring's ring buffer.

As shown in FIG. 1, the network processor 100 includes a plurality of micro engines 110 and a CPU 108. The producer thread 308 and consumer thread 310 may be in one of the plurality of micro engines 110 or the CPU 108. In a first producer-consumer case, both the producer thread and consumer thread are in micro engines 110. All put and get requests are sent from the micro engine to the ring manager 300 and the ring manager 300 has complete control of all spills and refills.

In another producer-consumer case, the producer thread 308 is in the CPU 108 and the consumer thread(s) 310 is in a micro-engine 110, the put request is sent to the ring manager 300. The CPU 108 keeps a local copy of the tail pointer and performs a put operation by writing directly to DRAM at the address provided by the tail pointer, incrementing the local tail pointer for each word that is written. The memory mapped tail register is updated after the put operation. However, the data is stored in DRAM and not in the ring buffer 106 so that it can be provided to a micro engine 110 in response to a get request. In order to copy the data from DRAM to the ring buffer 106, a refill check is triggered when the memory mapped tail pointer is written by the CPU. For example, a refill may be performed when there is at least a line of data, for example, 64 bytes for a DRAM burst cycle, in DRAM and there is enough room in the ring buffer 106 to hold the line of data or there are less than two lines of data in the ring buffer 106. Other refill policies may also be used.

In yet another producer-consumer case, the consumer thread 310 is in the CPU 108 and the producer thread(s) 308 is in a micro engine 110. In this case, the CPU 108 keeps a local copy of the head pointer for the ring and performs a get operation by reading directly from DRAM at the address provided by the head pointer, incrementing the local head pointer for each word. The memory mapped head register is updated after the get operation. The updating of the head pointer triggers a spill. For example, the spill may be performed when either there is at least one line of data in the ring buffer or there is less than a line in the ring buffer 106 and there is less than two lines in DRAM. Other spill policies may also be used.

Memory allocation in the ring buffer 106 for a particular ring is selected such that the long DRAM read latency is hidden, that is, sufficient data is stored in the ring buffer 106 to satisfy get requests while the refill operation is moving data to the ring buffer 106 from external memory 124.

The ring manager 300 performs read and write accesses directly to the external Dynamic Random Access Memory (DRAM) via the on-chip DRAM controller 116 for spill and refill operations. The producer and consumer threads 310, 308 also typically have access to the external DRAM. However, this is not shown in FIG. 3.

The head and tail pointers 306 may be implemented as hardware pointers managed in hardware. In the embodiment shown, the head and tail pointers 306 are managed in hardware so that the put and get operations are efficient for the producer and consumer threads 310, 308. Several threads may share data through rings, with new entries added to the tail of the ring by a producer thread 308 and entries removed from the head of the ring by a consumer thread.

Several parameters may be configured per ring. The parameters include the number of bytes allocated to the ring in the on-chip ring buffer and the number of bytes allocated to the ring in the off-chip memory, which is the size of the ring that is seen by the user of the ring.

The number of bytes allocated on-chip and off-chip are dependent on the latency of the off-chip memory, the average put and get operation rate and the burstiness of put operations relative to get operations. Write latency of the off-chip memory is defined as how long it takes to read data from the on-chip ring buffer 106 and write it to the off-chip memory upon a spill. Read latency of the off-chip memory is defined as how long it takes to read data from the off-chip memory and write it to the on-chip ring buffer 106 upon a refill. More capacity may be provided in the ring buffer 106 for a ring with bursty behavior to minimize spills and refills.

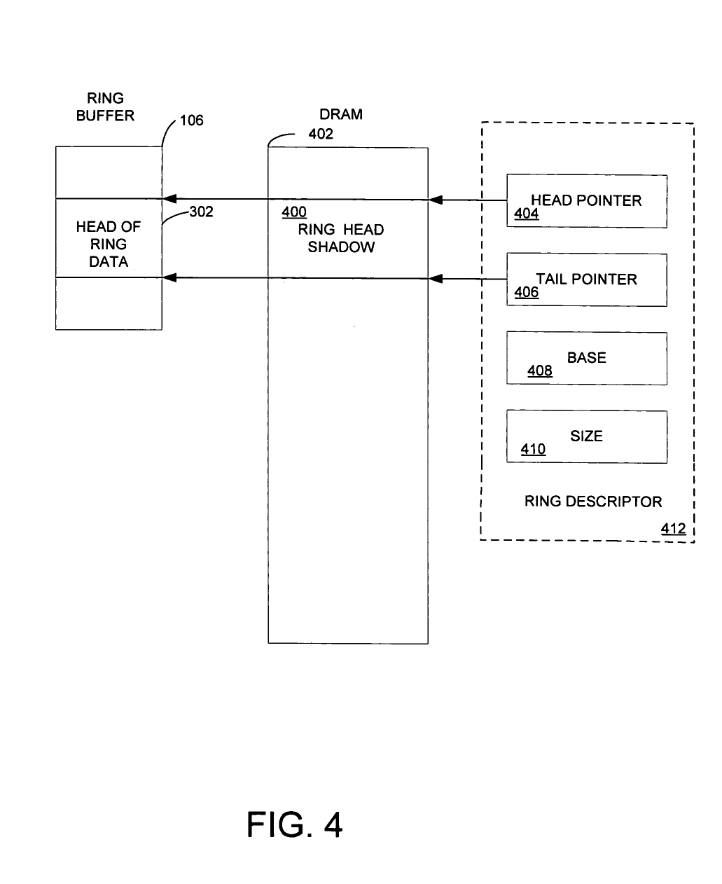

FIGS. 4-6 illustrate utilization of DRAM (external memory) 402 in the no spill, spill and refill case. As shown in FIGS. 4-6, the “ring capacity” as seen by the application is based on the amount of DRAM 402 that is allocated to the ring.

The head pointer 404 and tail pointer 406 are stored in an on-chip ring descriptor 412 associated with the ring. The ring descriptor 412 also includes a base address of the ring 408 and the size of the ring 410. The base pointer 408 and size of the ring 410 are initialized and not modified during operation.

Referring to FIG. 4, in a no spill case, all of the data for the ring is stored in the head of ring 302 allocated for the ring in the on-chip ring buffer 106, that is, both the head of the ring and the tail of the ring are stored in the ring buffer 106. The ring head shadow 400 in DRAM 402 is empty.

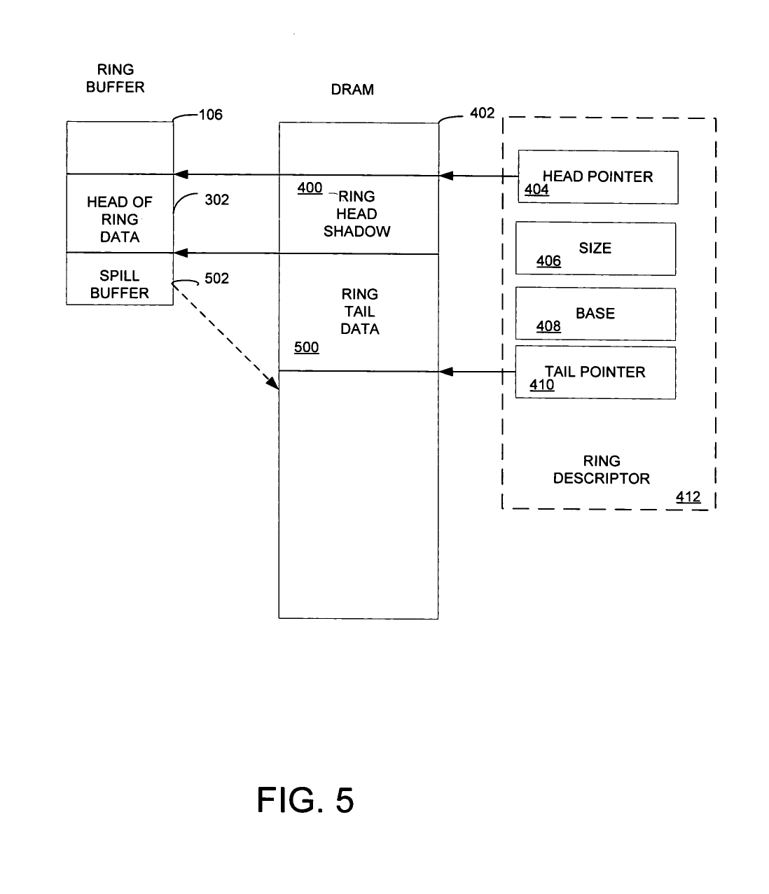

Turning to FIG. 5, in a spill case, the head of ring data 302 is stored in the ring buffer 106. The tail of the ring data 500 is stored in DRAM 402. In addition to storing the head of ring data 302, the ring buffer 106 also buffers bytes in a spill buffer 502 to coalesce writes for put operations prior to spilling a block of bytes to the DRAM 402 in a DRAM burst cycle. As shown, the DRAM 402 stores previously spilled ring data in ring tail data 500.

The head of ring data 302 in internal (on-chip) memory is always valid. However, the ring head shadow data 400 in DRAM 402 is not always valid. Specifically data in the DRAM 402 is not valid if the portion of the ring allocated in the ring buffer 106 was not full when the data was stored in the portion of the ring allocated in the DRAM, that is, through the put from the producer thread. In that case, the data is not written to DRAM. Although, the head of ring data 302 is not written to the ring head shadow 400 in DRAM 402, this does not create a problem because data that is removed from the ring in response to a get request from a consumer thread 310 is supplied from the portion of the ring that is stored in the ring buffer 106, that is, the head of ring data 302 associated with the ring in the ring buffer 106.

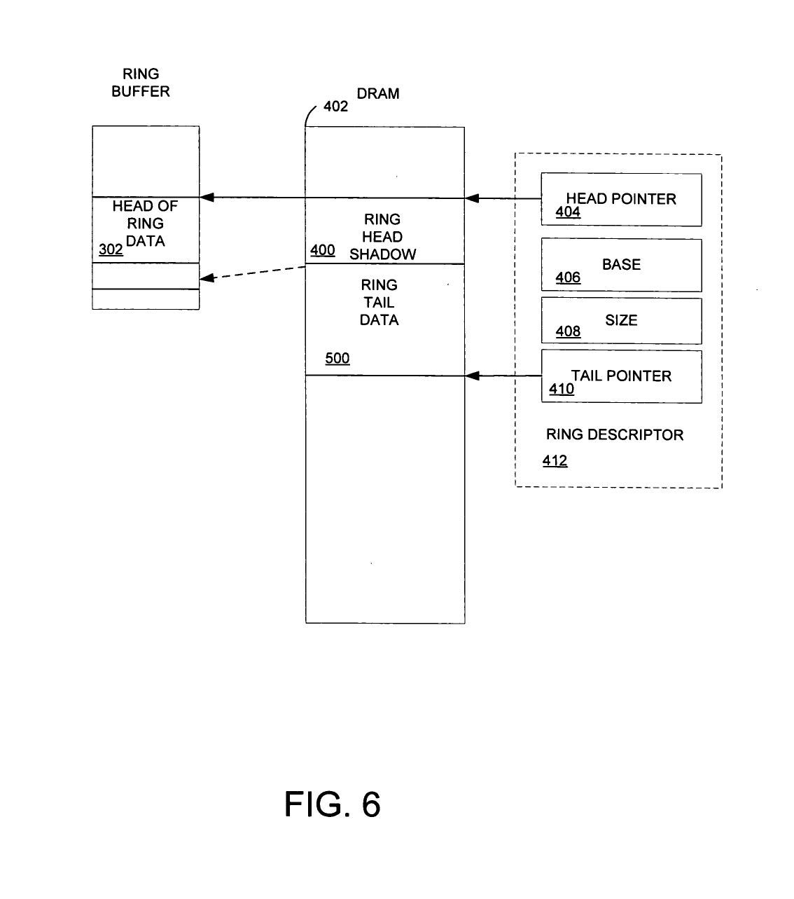

FIG. 6 illustrates a refill case. In the refill case, previously spilled data has been refilled from the DRAM 402 to the ring buffer 106 from the ring tail data 500 for the ring in DRAM 402. The spilled data stored in DRAM is refilled to the ring buffer 106 as the head of ring data 302 is emptied.

The write coalescing for spills for a given ring may be performed in the ring buffer 106 or in a shared pool of write buffers allocated to a ring when the head of ring data 302 portion of the ring buffer 106 associated with the ring is full.

FIG. 7 is a flow diagram illustrating an embodiment of a method for managing rings according to the principles of the present invention. The method will be described for managing a ring that includes head of ring data 302 shown in FIG. 3.

At block 700, initially, for example, after a system reset, all of the rings are empty. Upon detecting a request to add data or remove data from a ring, processing continues with block 702 to add data and with block 708 to remove data.

At block 702, if the request is to add data to the ring, for example, a put request from a producer thread 308, the ring manager 300 checks the head and tail pointers 306 associated with the ring to see if the ring buffer has space for the data. If there is space, processing continues with block 706. If not, processing continues with block 704.

At block 706, the ring manager 300 stores the data locally in the ring buffer 106 only. The data is not stored in external DRAM 402. Processing continues with block 700 to wait for another request.

At block 704, if there is no space in the on-chip memory (ring buffer 106) because the on-chip head of ring data 302 associated with the ring is full, the ring manager 300 redirects the data to DRAM 402. Processing continues with block 700 to wait for another request from a consumer thread or a producer thread.

At block 708, upon detecting a request to remove data from the ring, for example, a get request from a consumer thread 310, the ring manager 300 returns data stored in the local (on-chip) memory. If there is also some data for that ring stored in DRAM 402 which had been written there when the on-chip head of ring data 302 associated with the ring was full, the ring manager 300 copies the data from the external memory (DRAM) to the ring buffer 106 because the request to remove data created space in the ring buffer 106.

The range of the head and tail pointers maintained by the ring manager 300 is the size of the ring in DRAM 402. The head and tail pointers include information to indicate how much data is on the ring. The number of words stored in the ring indicates 1) whether or not the head of ring data 302 is full, and 2) where to write and read data to/from DRAM when the head of ring data 302 is full. For example, subtracting the value stored in the head pointer 404 from the value stored in the tail pointer 406 gives the number of words stored on the ring.

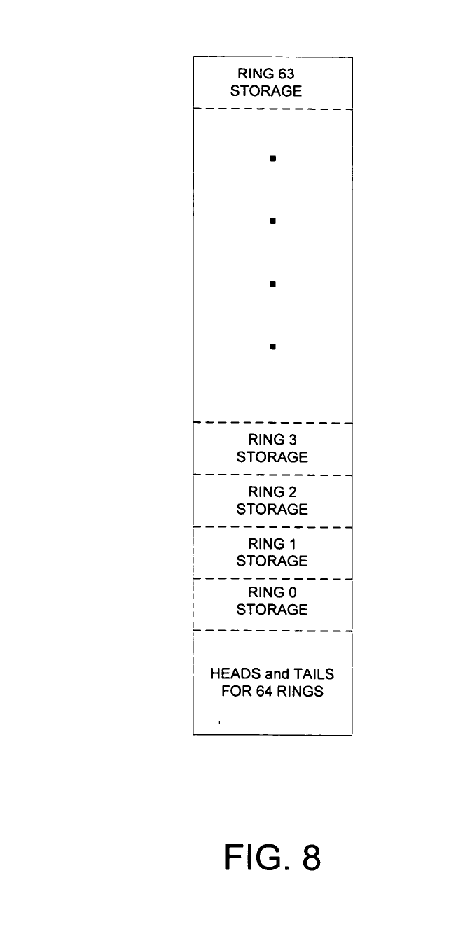

FIG. 8 illustrates an embodiment for utilizing the ring buffer 106 shown in FIG. 3. Memory in the ring buffer 106 may be allocated through the use of a configuration register. As discussed in conjunction with FIG. 3, some space in the ring buffer 106 is allocated for storing head and tail pointers for rings. For example, 16 bytes may be allocated per ring, with 4 bytes allocated for storing the head pointer, 4 bytes for storing the tail pointer, 1 byte for storing the ring size, and the other 7 bytes for storing miscellaneous control information such as, state flags, base of the ring in the ring buffer, size of the ring in the ring buffer and which write buffer is allocated to the ring for write coalescing.

The memory in the ring buffer 106 that is not used for head/tail pointer storage is used for ring storage. For example, the 16 bytes of head/tail information for 64 rings takes 1 kB, leaving 63 kB to be allocated for ring data storage, so each ring can be allocated an average of about 1 kB. The memory allocated for ring data storage for each ring may be different.

For example, a high bandwidth, high burstiness ring may be provided with a ring size of 256 kB. The ring has 64-bytes per line to match the DRAM burst size. 1 kB, that is, 16 lines of the ring is allocated in the ring buffer in order to avoid many spills into DRAM and 256 kB is allocated in DRAM.

For example, a small ring that never spills over into DRAM may be provided by allocating the same number of bytes in both the ring buffer 106 and the DRAM 402. As the memory allocated in the ring buffer for the ring is shadowed in DRAM, the ring does not spillover because no memory is available in DRAM for spillover.

An embodiment has been described in which low latency memory is internal (local or on-chip) and memory having a higher latency than the low latency memory is external (non-local or off-chip). However, the invention is not limited to a ring having internal and external memory. The invention applies to any ring having a low latency memory with the ability to spill over and be refilled from higher latency memory.

It will be apparent to those of ordinary skill in the art that methods involved in embodiments of the present invention may be embodied in a computer program product that includes a computer usable medium. For example, such a computer usable medium may consist of a read only memory device, such as a Compact Disk Read Only Memory (CD ROM) disk or conventional ROM devices, having a computer readable program code stored thereon.

While embodiments of the invention have been particularly shown and described with references to embodiments thereof, it will be understood by those skilled in the art that various changes in form and details may be made therein without departing from the scope of embodiments of the invention encompassed by the appended claims.

What is claimed is:

1. An apparatus comprising:
a low latency memory; and
a ring manger, the ring manager for managing a ring, the ring including a first portion allocated from the low latency memory and a second portion allocated from a memory having a higher latency than the low latency memory, data capable of being stored in the second portion when the first portion is full, upon removing data from the first portion, the first portion being refilled from the second portion.

2. The apparatus of claim 1, wherein the first portion is smaller than the second portion.

3. The apparatus of claim 1, wherein the first portion is dynamically allocated.

4. The apparatus of claim 1, wherein data at a head of the ring is stored in the first portion.

5. The apparatus of claim 1, wherein data at a tail of the ring is stored in the second portion.

6. The apparatus of claim 1, wherein the memory is an external Dynamic Random Access Memory (DRAM) and the low latency memory is an on-chip buffer.

7. The apparatus of claim 6, wherein the low latency memory includes a buffer for coalescing write data to allow an aligned memory access to match an integral multiple of DRAM burst size.

8. The apparatus of claim 1, wherein the first portion is refilled upon detecting space available to allow an aligned memory access to match an integral multiple of DRAM burst size.

9. The apparatus of claim 1, wherein the memory has a higher capacity than the low latency memory.

10. A method comprising:
allocating a first portion of a ring from a low latency memory and a second portion from a memory having a higher latency than the low latency memory;
storing data in the second portion when the first portion is full; and
upon removing data from the first portion, refilling the first portion from the second portion.

11. The method of claim 10, wherein the first portion is smaller than the second portion.

12. The method of claim 10, wherein the first portion is dynamically allocated.

13. The method of claim 10, wherein data at a head of the ring is stored in the first portion.

14. The method of claim 10, wherein data at a tail of the ring is stored in the second portion.

15. The method of claim 10, wherein the memory is a Dynamic Random Access Memory (DRAM).

16. The method of claim 15, wherein the low latency memory includes a buffer for coalescing write data to allow an aligned memory access to match an integral multiple of DRAM burst size.

17. The method of claim 10, wherein the first portion is refilled upon detecting space available to allow an aligned memory access to match an integral multiple of DRAM burst size.

18. The method of claim 10, wherein the memory has a higher capacity than the low latency memory.

19. An article including a machine-accessible medium having associated information, wherein the information, when accessed, results in a machine performing:
allocating a first portion of a ring from a low latency memory and a second portion from a memory having a higher latency than the low latency memory;
storing data in the second portion when the first portion is full; and
upon removing data from the first portion, refilling the first portion from the second portion.

20. The article of claim 19, wherein the first portion is smaller than the second portion.

21. The article of claim 19, wherein the first portion is dynamically allocated.

22. A system comprising:
a Dynamic Random Access Memory (DRAM);
a low latency memory; and
a ring manger, the ring manager for managing a ring, the ring including a first portion allocated from the low latency memory and a second portion allocated from the DRAM, data capable of being stored in the second portion when the first portion is full, upon removing data from the first portion, the first portion being refilled from the second portion.

23. The system of claim 22, wherein the first portion is smaller than the second portion.

24. The system of claim 22, wherein the first portion is dynamically allocated.
